(19) United States
(12) Patent Application Publication
(10) Pub. No.: US 2006/0269113 A1
(43) Pub. Date: Nov. 30, 2006

(54) Method for image generation with an imaging modality

(76) Inventors: Lutz Gundel, Erlangen (DE); Helmut Kropfeld, Forchheim (DE)

Correspondence Address: SCHIFF HARDIN, LLP;PATENT DEPARTMENT, 6600 SEARS TOWER, CHICAGO, IL, 60606-6473, US

(21) Appl. No.: 11/138,557

(22) Filed: May 26, 2005

(30) Foreign Application Priority Data
May 26, 2005 (DE) 10 2004 025 685.3

(51) Int. Cl. G06K 9/00

(52) U.S. Cl. 382/131

(57) ABSTRACT

In a method for image generation with an imaging modality, in particular a computed tomography system, in which measurement data for a sequence of 2D slice images of a subject volume are acquired with the imaging modality, image data for the 2D slice images are reconstructed from the measurement data and the image data are post-processed for generation and display of one or more secondary images, the post-processing and display is begun on the basis of already-reconstructed image data before all image data are completely reconstructed for the 2D slice images. The image data are initially reconstructed with a larger slice separation and are subsequently completed in a by a reconstruction of the entire subject volume with image data of remaining intermediate images, such that the representation of the one or more secondary images is completed by the post-processing of the image data of the intermediate images over time.

### BACKGROUND OF THE INVENTION

1. Field of the Invention

The present invention concerns a method for image generation with an imaging modality, in particular a computed tomography apparatus of the type wherein measurement data for a sequence of 2D slice images of a subject volume are acquired with the imaging modality, image data for the 2D slice images are reconstructed from the measurement data, and the image data are post-processed for generation and display of one or more secondary images, and wherein the post-processing and display is begun on the basis of already-reconstructed image data before all image data are completely reconstructed for the 2D slice images.

2. Description of the Prior Art and Related Subject Matter

The present invention is in the field of tomography-capable imaging modalities with which waves or rays penetrating or created in an examination subject can be acquired from different directions with regard to the system axis. For example, such modalities use x-rays emitted from an x-ray source that penetrates the examination subject. Falling into this category are x-ray computed tomography apparatuses, in particular with x-ray tubes that can continuously revolve around the system axis, as well as C-arm x-ray apparatuses. Imaging modalities in the sense of the present invention furthermore encompass ultrasound tomography apparatuses in which ultrasound waves penetrate the examination subject and are detected. Imaging modalities in the sense of the present invention also include tomography-capable imaging medical examination apparatuses in nuclear medicine, wherein this case the examination subject is self-radiating (i.e., the radiation originates intracorporeally). Falling into this category are, for example, positron-emission tomography apparatuses (PET) and SPECT apparatuses (single photon emission computed tomography).

Images acquired with modern imaging medically-related apparatuses, for example with a multi-slice CT (MSCT) apparatus, exhibit a relatively high resolution in all directions such that amplified 3D exposures can be created therewith. The volume data sets obtained with such 3D acquisitions, however, contain a significantly higher data quantity than image data sets from conventional two-dimensional images, which is why an evaluation of volume data sets is relatively time-consuming. The actual acquisition of the volume data sets lasts a few seconds, but usually a half an hour or more is required for the editing and preparation of a volume data set. Volume data sets often represent not only an unmanageable data stream, but also involve storage capacity problems given archiving or caching.

For image acquisition and image generation with a computed tomography apparatus, measurement data are acquired for a sequence of 2D slice images of a subject volume of the examination subject. The two-dimensional slice images are initially reconstructed from these measurement data (if applicable after correction of specific machine-specific properties) using known radiation energy converter methods. These images represent an axial slice stack of the examination volume, with which a diagnostic finding can be made. The 2D slice images, however, frequently are not directly used for diagnosis, but are transferred to a computer station for three-dimensional post-processing of the image data, in which secondary images are generated that make a diagnosis easier for the doctor. Examples of post-processing methods, in particular for 3D visualization, are MPR (multiplanar reformatting), MIP (maximal intensity projection), MinilP (minimal intensity projection), SSD (shaded surface display), VRT (volume rendering) as well as other methods for perspective or three-dimensional representation of the volume data set obtained via the image data of the slice stack.

The reconstruction of the 2D slice images and the post-processing for generation of the secondary images typically ensue purely sequentially. Given slow reconstruction computers and the large data quantities that are generated by modern multi-line computed tomography systems with high resolution, this means a significant waiting time for the operator until receipt of the secondary images on the basis of which the diagnosis can begin.

To improve this situation, a method according to the species for image generation with an imaging modality of the type initially described is known from German OS 95 41 500, in which a two-dimensional MPR slice image, which represents an arbitrary orientation relative to the slices of the 2D slice images, is calculated and displayed by post-processing during the reconstruction of 2D slice images from the already-reconstructed image data. This secondary image grows in the course of the reconstruction, such that an evaluation by the user is already enabled during data acquisition and reconstruction.

A method for image generation with an imaging modality, in particular a computed tomography apparatus, is known from subsequently published German OS 103 45 073 in which a post-processing of the already-reconstructed image data ensues during the image reconstruction of 2D slice images, in order to obtain an intermediate image for planning the post-processing for calculation of a secondary image. The intermediate image is calculated with less precision and/or a shorter calculation time than the secondary images selected after implementation of the planning. The intermediate image in particular offers a three-dimensional overview representation of the examined subject volume, with which the user can establish the parameters for the subsequent calculation of the secondary images, which is begun only after the implementation of this planning.

### SUMMARY OF THE INVENTION

An object of the present invention is to provide a method for image generation with an imaging modality, in particular a computed tomography apparatus, in which the waiting time until display of a secondary image is shortened.

This object is achieved in accordance with the invention by a method for image generation with an imaging modality, in particular a computed tomography apparatus, wherein measurement data for a sequence of 2D slice images of a subject volume are acquired with the imaging modality, image data for the 2D slice images are reconstructed from the measurement data and the image data are post-processed for generation and display of one or more secondary images and wherein the post-processing and display of the secondary images is begun on the basis of already-reconstructed image data before all image data for the 2D slice images are completely reconstructed and wherein reconstruction of the 2D slice images keeping pace with the measurement ensues with high quality, but with a slice interval or increment that is enlarged relative to the slice interval of the measurement, such that a reduced spatial resolution results in the z-direction (the direction of the system axis in this initial reconstruction). The secondary image thus can be calculated and displayed relatively quickly using this lower resolution in the z-direction. The missing intermediate images are subsequently reconstructed such that the post-processed subject image is initially displayed coarsely and is subsequently displayed refined and completed by successive inclusion of the image data of the intermediate images.

In an embodiment, a constant increment is not used for the coarse reconstruction of the image data but instead the 2D slice images of interest are predetermined before the reconstruction and are reconstructed first. The reconstruction of the missing intermediate images then ensues subsequently. One or more subject regions of interest can initially be shown in this manner in the secondary image, which is subsequently completed in the remaining regions, in particular in the boundary regions.

The first step (course reconstruction procedure) preferably begins during the acquisition of the measurement data, so that the user can already begin the diagnosis or evaluation of the secondary image during the measurement (scan).

According to a variant of the invention, the image data for the 2D slice images are initially reconstructed in the first step only for predeterminable slices of the subject volume, for example each nth acquired slice, and/or with a reduced image quality, for example with reduced resolution, and in the second step are subsequently replaced or completed by a reconstruction with higher image quality and/or the entire subject volume. In this manner the secondary images generated from the reconstructed image data are initially displayed only roughly and/or for the region of interest and are subsequently displayed refined or complete.

The user thus obtains a rough representation of the secondary image relatively early for making a finding, or with an already qualitatively high-quality representation of the subject region important to the user. The rough representation is refined with increasingly finer reconstruction of the image data of the 2D slice images in the course of time. At the beginning of the representation with the subject region of interest, the remainder of the subject volume is supplemented in the course of time, since normally this must likewise be evaluated and archived.

The present method is explained in detail below using the example of computed tomography examinations. It is understood, however, that the method is applicable to other imaging techniques (as described above) in which a comparable problem exists. The basis of the present method is a temporal interleaving of the CT reconstruction with the post-processing in connection with an initially selective and/or rough image reconstruction. The post-processing for the receipt of the secondary images is already begun as soon as the first 2D slice images have been reconstructed. If the post-processing is, for example, the calculation of a three-dimensional subject, the image can already be rotated or windowed on the screen by the user while it is still growing or being refined by the continuing CT reconstruction.

In a further embodiment of the present method, the image data for the 2D slice image are initially reconstructed with reduced quality in order to enable a fast display of the secondary image based on the initially-reconstructed image data. The 2D slice image are subsequently reconstructed in higher quality and the corresponding image regions of the displayed secondary image are therewith updated in series while the user already begins the evaluation of the secondary image for a diagnosis based thereon.

The 2D slice images acquired in the implementation of an examination with a computed tomography apparatus are known as transverse slice images or section images in a slice plane perpendicular to the system axis (z-axis) of the computed tomography scanner. Any image representations deviating from the already-existing 2D slice images can be acquired as a secondary image or secondary images obtained by the post-processing according to the present method. The secondary images can represent sagittal images, coronal images or transverse images. Sagittal images are images in a plane parallel to the plane of symmetry (medial plane) of the examination subject. Coronal images are images in a plane perpendicular to the sagittal plane and the transverse plane. The coronal plane is also called the frontal plane. A secondary image according to the present method generally can be a 2D or 3D image that is not a 2D slice image. Examples for secondary images are 2D images that have been calculated by means of MPR with a different orientation than that with which the slice plane has been calculated, or 3D images that have been calculated by means of VRT, MIP, SSD etc. The appropriate methods for obtaining the corresponding secondary images from the image data of the 2D slice images are known to the person of ordinary skill in the art.

In an embodiment of the present method, at least portions of the secondary image or of the secondary images are updated by re-measurement (re-acquisition of data) of the associated region of the subject volume. The re-acquisition can ensue in a computed tomography scanner either by means of a scan without table (bed) movement or by means of a short spiral scan. Particularly in the case of dynamic applications (such as, for example, fluoroscopy), this embodiment enables updating of a region of the subject volume in which an instrument (for example a biopsy needle or a catheter) is guided. Also, by suitable segmentation of the image data, only the guided instrument can be updated in the secondary image.

Furthermore, in this embodiment it is possible to specifically identify (for example to mark in color) the temporally-updated data or differences between the original data and the updated data in the representation. This can be an updating after a short time such as, for example, in operating procedures or interventions. Alternatively, a long time (for example days or weeks) can exist between the two measurements, such as occurs, for example, in the diagnosis of the course of an illness.

A smoothing within the secondary image between new and old data may be necessary in order to reduce transfer effects that are created due to slight movements of the subject or of the observed subject components, for example organs. An updating of the data of the secondary image with color identification, for example, can be advantageous with the addition of contrast agent after the first-time display of the secondary image. The control of the re-measurement at the updated region of the subject volume can ensue indirectly by control of the CT bed using operating elements mounted at the CT apparatus, by speech control or by means of a navigation system that determines the position of a pointer positioned on the slice to be updated in the representation and that uses this information for the control of the CT bed.

### DESCRIPTION OF THE DRAWINGS

FIG. 1 schematically illustrates a modality (fashioned as a CT apparatus) for implementation of the present method.

FIG. 2 schematically illustrates the image generation according to an exemplary embodiment of the present method.

FIG. 3 shows a further example of the method workflow in the implementation of the present method.

FIG. 4 shows another example for the method workflow in the implementation of the present method.

FIG. 5 shows another example for the method workflow in the implementation of the present method.

### DESCRIPTION OF THE PREFERRED EMBODIMENTS

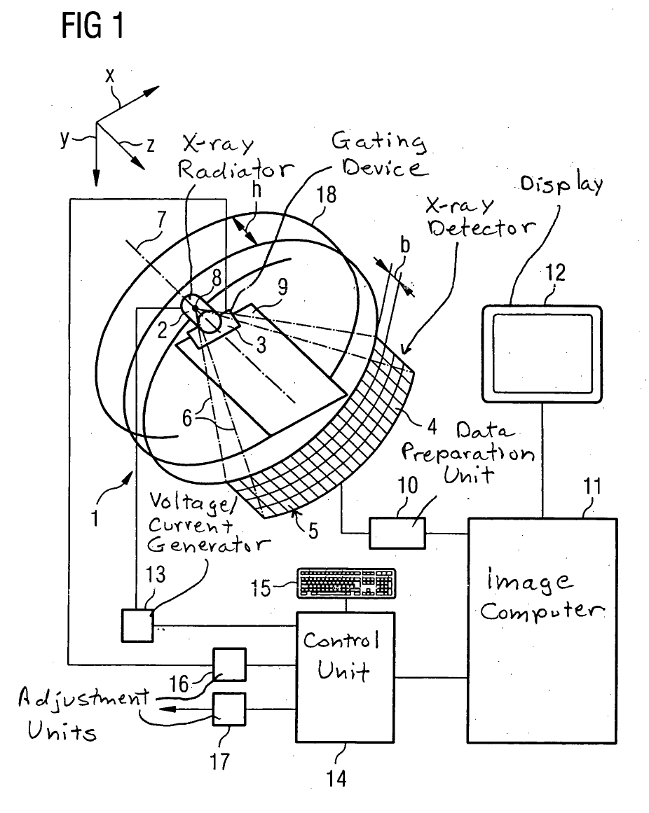

A CT apparatus 1 of the third generation is schematically shown in FIG. 1. Its measurement arrangement (scanner) has an x-ray radiator 2 with a source-proximate gating device 3 positioned in front of the x-ray radiator 2 and an x-ray detector 5 fashioned as a multi-row or laminar array of a number of rows and columns of detector elements 4. For clarity, only four rows of detector elements 4 are shown in the representation of FIG. 1. The x-ray detectors, however, may have further rows of detector elements 4, also with different width b. The x-ray detector 5 can be fashioned as a solid-state matrix detector system, in particular as a planar image detector and/or as a detector that has a scintillator layer as well as an associated photodetector matrix. Such detectors have the advantage that they can also be produced with an active area as 2D image detectors, suitable for use with low manufacturing expenditure.

The x-ray radiator 2 with the gating device 3 and the x-ray detector 5 (which may have been an associated beam diaphragm (not shown)) are mounted opposite one another on a rotary frame such that a pyramidal x-ray beam emitted by the x-ray radiator 2 in the operation of the CT apparatus 1 and gated by the adjustable gating device 3, the edge rays of which are designated 6 in FIG. 1, strikes the x-ray detector 5. The rotary frame can be placed in rotation around a system axis 7 by means of a drive device (not shown). The system axis 7 runs parallel to the z-axis of the Cartesian coordinate system shown in FIG. 1. The columns of the x-ray detector 5 likewise run in the direction of the z-axis while the rows (the width b of which is in the direction of the z-axis and is, for example, 1 mm) run transverse to the system axis 7, or the z-axis.

In order to be able to bring the examination subject (for example a patient) into the beam path of the x-ray beam, a positioning device 9 is provided that can be shifted parallel to the system axis 7, thus in the direction of the z-axis. The shifting ensues with a synchronization between the rotational movement of the rotary frame and the translational movement of the positioning device 9. The ratio of translational speed to rotational speed can be adjusted by specification of a desired value for the feed h of the positioning device 9 per rotation of the rotary frame.

A subject volume of an examination subject located on the positioning device 9 can be examined by means of volume scanning by the operation of this CT apparatus. Given a spiral scan, many projections are acquired from various directions during rotation of the rotary frame with simultaneous translation of the positioning device 9 per rotation of the rotary frame. In such a spiral scan, the focus 8 of the x-ray radiator 2 moves on a spiral path 18 relative to the positioning device 9. A sequence scan is also possible as an alternative to a spiral scan.

The measurement data read out in parallel from the detector elements 4 of each active row of the detector system 5 during the spiral scan and corresponding to the individual projections are subjected to an A/D conversion in a data preparation unit 10, are serialized, and transferred as raw data to an image computer 11 that displays the result of an image computer on the display unit 12, for example a video monitor.

The x-ray radiator 2, for example an x-ray tube, is supplied with the necessary voltages and currents by a generator unit 13 (optionally co-rotating). In order to be able to adjust the voltages and currents to the respective necessary values, a control unit 14 with a keyboard 15 that allows the necessary adjustments is associated with the generator unit 13. The other operation and control of the CT apparatus 1 also ensues by means of the control unit 14 and the keyboard 15. Among other things, the number of the active rows of the display elements 4, and therewith the position of the gating device 3 and of the optional, detector-proximate beam diaphragm, can be set, for which the control unit 14 is connected with adjustment units 16, 17 associated with the gating device 3 and the optional, detector-proximate beam diaphragm. Furthermore, the rotation time that the rotary frame requires for a complete rotation can be set.

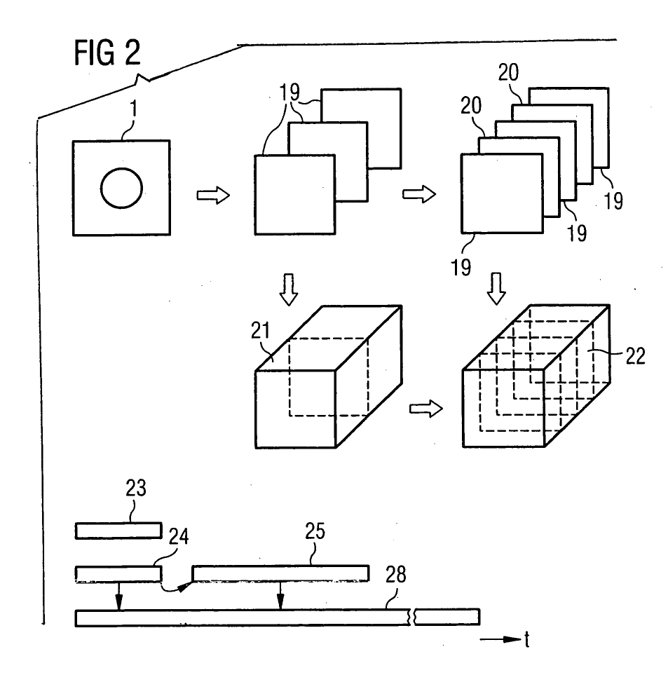

For illustration, FIG. 2 shows in the upper part an example for the workflow of the implementation of the present method, in the lower part an example for the temporal relation of the individual method steps.

In this exemplary embodiment, a volume scan of a subject volume (for example a body part of a patient) is effected with the CT apparatus 1 by means of a spiral scan in order to acquire 2D slice images of this subject volume. In the present example, 2D slice images 19 with a coarser increment or, respectively, slice interval than the slice interval realized in the measurement are initially reconstructed from the measurement data acquired during the spiral scan. The reconstruction of the 2D slice images 19 with the larger increment still ensues during the implementation of the scan. As soon as the first reconstructed image data are acquired, post-processing for generation of a 3D volume image as well as the display of this image are begun parallel to this reconstruction. A rough 3D volume image 21 is created in this manner due to the rougher increment with which the 2D slice images 19 are initially reconstructed. The still-missing intermediate images 20 are subsequently reconstructed from the measurement data and are post-processed to supplement or refine the rough 3D volume image 21. A refined 3D volume image 22 is obtained at the end of this process.

From the lower part of FIG. 2 it can be seen that the secondary application 28, i.e. the post-processing for generation of the secondary image (in the present example a 3D volume image 21 or, respectively, 22), has already been begun as soon as the first 2D image data are acquired from the online reconstruction 24 with the rougher increment. The online reconstruction 24 in turn begins immediately after the beginning of the measurement and receipt of the first measurement data by the CT apparatus 1. The duration of the measurement scan 23 is likewise indicated. After ending the online reconstruction 24 with the reduced resolution in the z-direction, a reconstruction 25 of the still-missing intermediate images 20 automatically ensues in the finer increment, the results of which are incorporated into the secondary application 28.

In this manner, the user already very quickly obtains a rough secondary image 21 that is refined into the qualitatively high-grade secondary image 22 in the course of time. The evaluation of the secondary image thus can begin immediately.

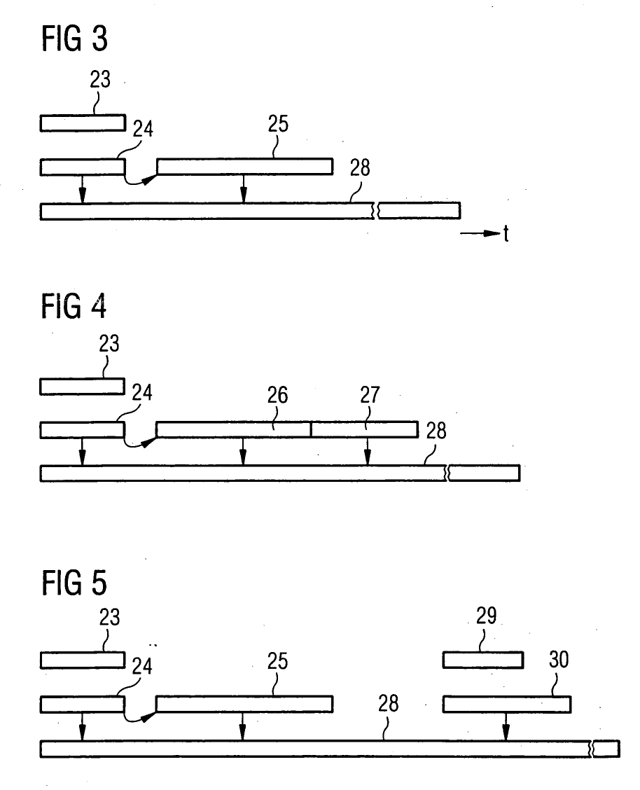

In a further embodiment of the present method schematically represented by FIG. 3, an online reconstruction 24 with reduced image quality ensues during the scan 23. This reduced image quality, which can be adjusted via corresponding selection of the reconstruction parameters, significantly reduces the reconstruction time of the 2D slice images. The secondary application 28 can be begun at the same time. After the end of the online reconstruction 24, a reconstruction 25 of higher quality automatically ensues, the results of which are successively incorporated into the secondary application 28 to generate the secondary image and there replace the image components that have been generated from the image data of the slice images of lower quality.

In this embodiment, the user thus also can immediately begin the evaluation based on a secondary image of lower quality that converts into a secondary image with higher image quality in the course of time.

FIG. 4 shows a further exemplary embodiment for implementation of the present method. Here as well an online reconstruction 24 of the 2D slice images with lower quality is initially implemented in parallel with the scan 23, on the basis of which 2D slice images with lower quality the secondary application 28 can simultaneously be begun. After the end of the online reconstruction 24, a reconstruction 26 of the most interesting regions of the subject volume initially ensues with higher quality, the results of which are likewise simultaneously incorporated into the secondary application 28. Finally, the still-missing regions are then automatically reconstructed (reference character 27) and supplied to the secondary application 28.

In a further embodiment of the present method in which the generation and representation of the secondary image can ensue according to the preceding examples, a re-scan 29 of at least one predeterminable region of the already previously-measured subject volume is subsequently implemented. At the same time, a 2D slice image (or a plurality of 2D slice images) is in turn reconstructed (reference character 30) from the acquired new measurement data, the image data of which are incorporated into the secondary application 28. Either the already-existing data of the corresponding newly-measured subject region are replaced with these data or the new data can be additionally visualized via color marking. These last-cited steps naturally can be arbitrarily repeated in order to respectively update the complete subject volume.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for generating an image comprising the steps of:
in a data acquisition system that interacts with a subject, acquiring measurement data for a sequence of 2D slice images, respectively separated by first intervals, of a volume of the subject;
beginning post-processing of said measurement data for reconstructing an image of the volume before completing acquisition of all measurement data from said volume; and
in said post-processing of said measurement data, initially reconstructing a secondary image of the volume with a second slice interval that is larger than said first slice interval using currently available measurement data, and displaying said secondary image, and subsequently reconstructing an image of an entirety of the volume as measurement data for 2D slice images within said second interval become available.

2. A method as claimed in claim 1 comprising beginning reconstruction of said secondary image during acquisition of said measurement data.

3. A method as claimed in claim 1 comprising reconstructing said secondary image with a first image quality and subsequently reconstructing said image of the entirety of said volume with a second image quality that is higher than said first image quality.

4. A method as claimed in claim 3 comprising reconstructing said secondary image with a first resolution and subsequently reconstructing said image of the entirety of said volume with a second resolution that is higher than said first resolution.

5. A method as claimed in claim 1 during or after reconstruction of said image of the entirety of said volume, acquiring new measurement data with said data acquisition system for at least one 2D slice image of a predetermined region of said volume, reconstructing an image of said predetermined region of said volume using said new measurement data, and combining said image of said predetermined region of said volume with said image of the entirety of said volume.

6. A method as claimed in claim 5 wherein the step of combining said image of said predetermined region with said image of the entirety of said volume comprises updating said image of the entirety of said volume with said image of said predetermined region.

7. A method as claimed in claim 5 wherein the step of combining said image of said predetermined region with said image of the entirety of said volume comprises superimposing said image of said predetermined region on said image of the entirety of said volume.

8. A method as claimed in claim 5 comprising removing said subject from said data acquisition system between acquisition of said measurement data and acquisition of said new measurement data.

9. A method as claimed in claim 5 comprising producing a combined image by combining said image of said predetermined region with said image of the entirety of said volume and, in said combined image, emphasizing differences between said measurement data and said new measurement data.
